(19) United States
(12) Patent Application Publication
(10) Pub. No.: US 2012/0131000 A1
(43) Pub. Date: May 24, 2012

(54) METHOD AND APPARATUS FOR IDENTIFYING TALENT BY MATCHING WITH THE GIVEN TECHNICAL NEEDS AND BUILDING TALENT PROFILE FROM MULTIPLE DATA SOURCES

(75) Inventors: Balraj SUNEJA, Wilton, CT (US); Glenn Wienkoop, Cincinnati, OH (US); Douglas S. Dennis, Loveland, OH (US); David G. Theus, Florence, KY (US); Larry A. Huston, Covington, KY (US); Deepak Ramachandran, Westport, CT (US)

(73) Assignee: inno360, Inc., Cincinnati, OH (US)

(21) Appl. No.: 13/278,311

(22) Filed: Oct. 21, 2011

Related U.S. Application Data
(60) Provisional application No. 61/405,401, filed on Oct. 21, 2010.

(51) Int. Cl. G06F 17/30

(52) U.S. Cl. 707/723; 707/E17.014

(57) ABSTRACT

A system includes a server processor coupled to the Internet. The server processor is configured to receive a problem statement from a user and automatically generate a search query based on the problem statement. The server processor is configured to use the search query to perform a database search of a plurality of databases that are stored in a machine readable storage media accessible via the Internet and/or in house data sources available within the internal computer network. The server processor is configured to generate and output an identification of a ranked set of documents and/or information to the user in response to the search query. The server processor is configured to receive from the user an identification of a subset of the ranked set, and automatically extract a set of names of experts from the subset.

This application claims the benefit of U.S. Provisional Patent Application No. 61/405,401, filed Oct. 21, 2010, which is incorporated by reference herein in its entirety.

### FIELD

This disclosure relates to the handling of expert profile information and, more particularly, to automatically creating a search criteria and then finding and associating expert profile information of an individual from multiple data sources.

### BACKGROUND

Information about the expertise of an individual is typically maintained/scattered at many different data sources. Data sources include for example, education history, technical papers, patents, journals, news, professional networks, and social media. Data available at these sources typically include articles, journals and other information which indicates the areas of expertise of an individual. Such data is largely free form text with some data elements in fielded format including XML or relational structures. Additional profile data extraction can be accomplished via social site linkages, and from the public sources of information on the world wide web (Internet) as well as in house sources available within the internal computer network. Further the data also includes information about the experts' whereabouts and contextual information such as name, address, email address, education and employment history but this information could be scattered across different data sources.

Many data providers allow users and authorized applications access to information regarding individual's profile and expertise via the Internet or other remote connection mechanism (often referred to as “online service”).

Profile and expertise information (such as areas of specialization, technical paper content, and employment history) is associated with individuals but at different data sources different identifiers are used for the same person. Further the information at different data sources can be entirely different. For example, technical papers may be available at one source, contact information may be available at a second source, employment history at a third source and patent information at a fourth source with no significant overlap. Further, the names used may have numerous variations and there may be several persons with the same name.

### SUMMARY

In some embodiments, a method comprises: (a) receiving a problem statement from a user; (b) automatically generating a search query based on the problem statement; (c) using the search query to perform a database search of a plurality of databases that are stored in a machine readable storage media accessible via one or more of the Internet or a local area network or a local drive; (e) generating and outputting an identification of a ranked set of documents and/or information to the user in response to the search query; (f) receiving from the user identification of a subset of the ranked set; and (g) automatically extracting a set of names of experts from the subset.

In some embodiments, a persistent machine-readable storage medium is encoded with computer program code, such that when the computer program code is executed by a processor, the processor performs the method.

In some embodiments, a system includes a server processor coupled to the Internet. The server processor is configured to receive a problem statement from a user and automatically generate a search query based on the problem statement. The server processor is configured to use the search query to perform a database search of a plurality of databases that are stored in a machine readable storage media accessible via one or more of the Internet, or a local area network or a local drive. The server processor is configured to generate and output an identification of a ranked set of documents and/or information to the user in response to the search query. The server processor is configured to receive from the user an identification of a subset of the ranked set, and automatically extract a set of names of experts from the subset.

### BRIEF DESCRIPTION OF THE DRAWINGS

FIG. 1 is a schematic illustration of an open innovation process that uses the present invention to find Talent and build a comprehensive and consolidated profile of the found Talent from multiple data sources.

FIG. 2 illustrates an example network environment in which various servers, computing devices, and profile management systems exchange data across a network, such as the Internet.

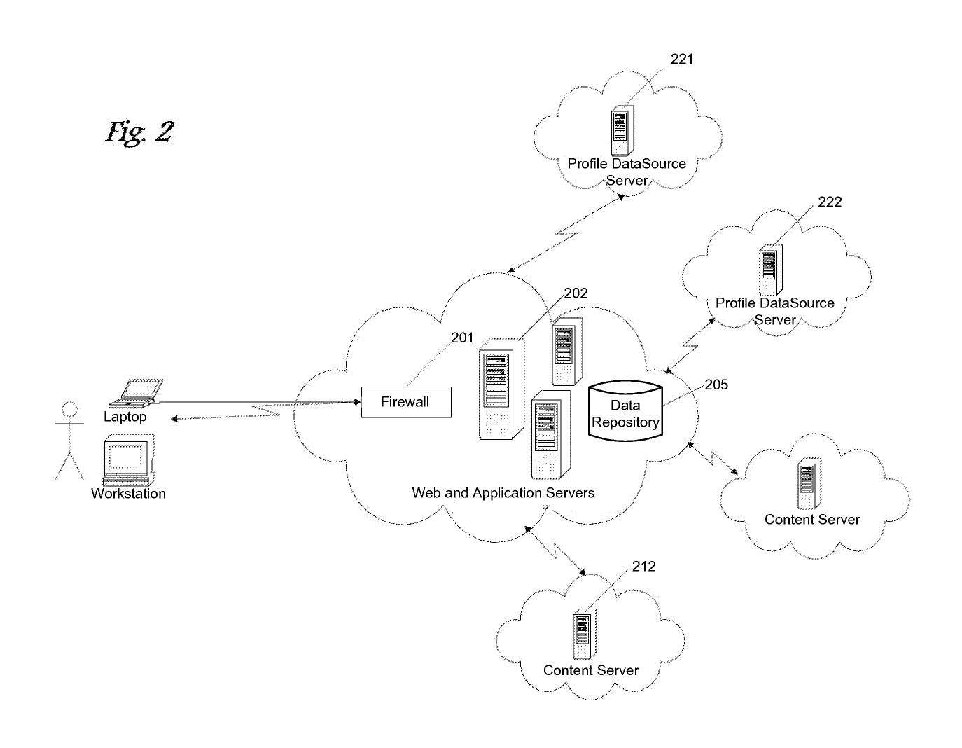

FIG. 3 is a block diagram that illustrates a high level architecture of the present invention.

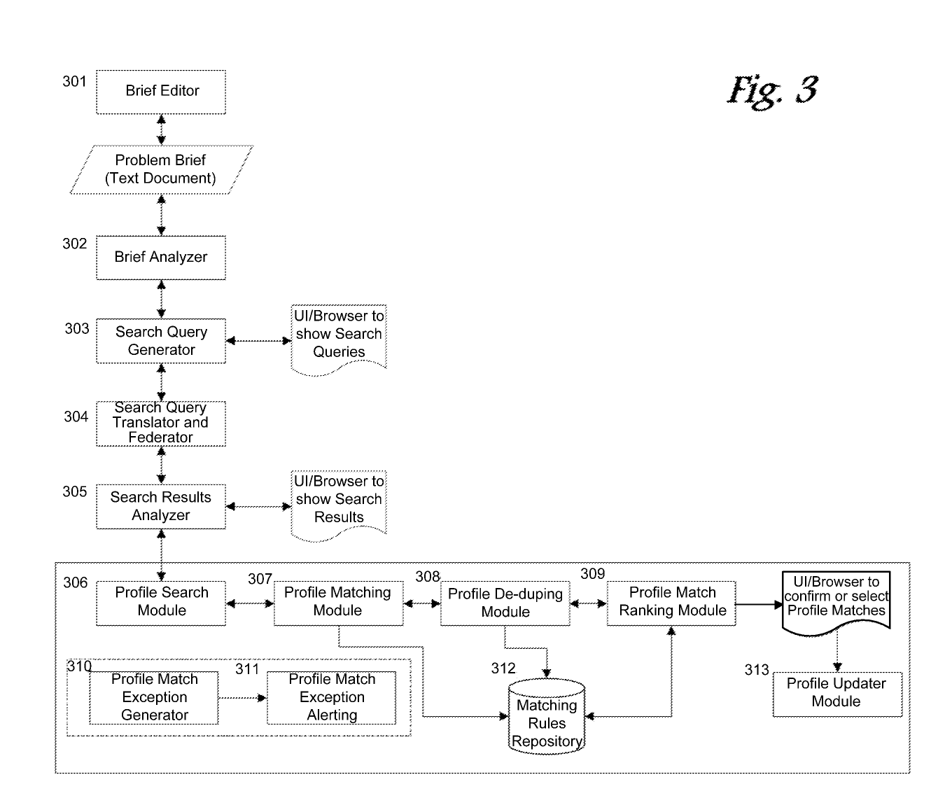

FIG. 4 is a flow chart that describes the detailed operation and steps in the profile matching and profile builder system along with an exception management process.

### DETAILED DESCRIPTION

This description of the exemplary embodiments is intended to be, read in connection with the accompanying drawings, which are to be considered part of the entire written description.

Like numerals are used throughout this specification and in the drawings to identify modules, operations and elements of the system.

The systems and methods described herein allow an open innovation practitioner to find experts for a given need and stitch together information about an expert from multiple different data sources as described above. The systems and methods allow a user to find an expert matching talent to any given expertise requirement and find all information available about that expert in all available data (content) sources. The described systems and methods automate many of the tasks required to find experts and build a composite profile about the experts for a given problem definition. Further, the systems and methods allow users to manually modify and augment the profile information collected under these processes.

In some embodiments, a request is received to identify experts (Talent) matching a given requirement description, and thereafter to build and access profiles of such experts. The system creates a search criteria based on the requirements description and then automatically performs searches for expertise at all data sources which may include remote data sources accessed over the Internet as well as in house data sources (e.g., local area network or a local drive) available within the internal computer network. Where the necessary expertise is found, the profile information is retrieved from the corresponding data source. Using rules established and continually adapted, the profile of the identified talent/expert is then identified and retrieved from every other data source and combined to make a consolidated and comprehensive profile. The consolidated profile contains an identifier at each remote data source and using this identification the talent/expert profile is continually kept updated. Matched talent can be an individual or a corporation or any other organization or “entity”. An exception identification process is established to identify any cases where identification of the expertise cannot be established in other data sources; such exceptions are then manually analyzed by an individual and such exceptions are used to improve the profile matching rules.

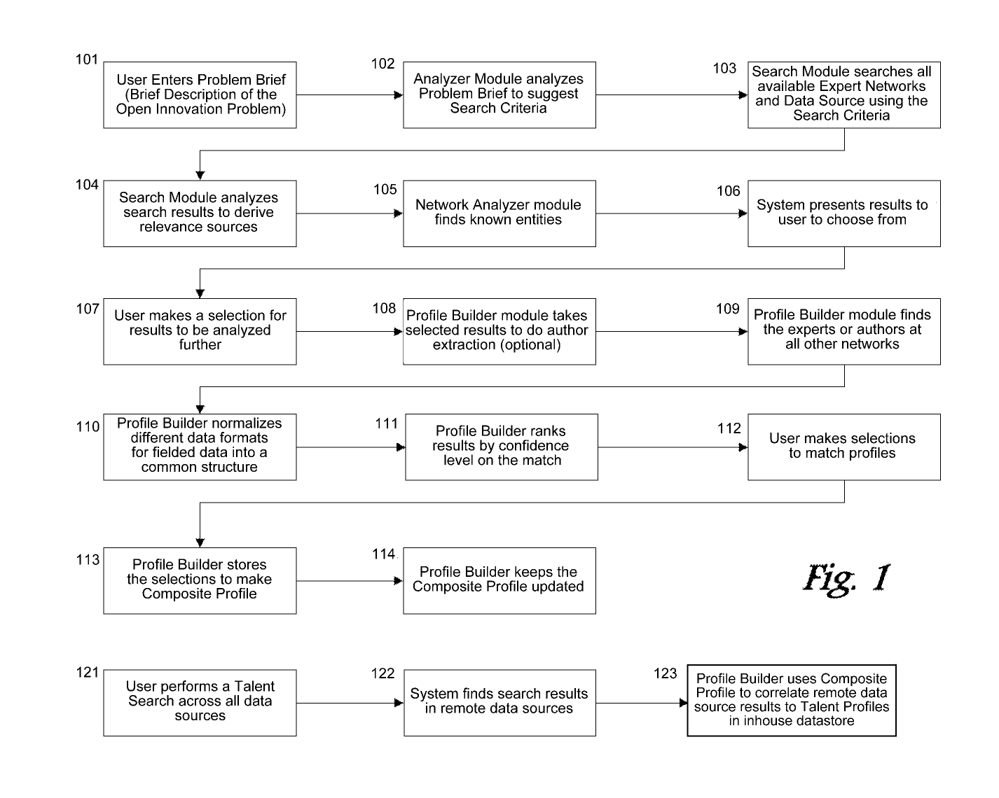

FIG. 1 describes an open innovation process that finds Talent and builds a comprehensive and consolidated profile of the found Talent from multiple data sources.

A Brief Editor module 101 allows the user to create a Brief where a Brief is a summarized and short problem statement describing the needs of the innovation opportunity. Such an innovation opportunity could belong to any of the areas that the customer is interested in e.g. technology, design, processing, packaging and marketing. The user uses a WYSIWYG (what you see is what you get) HTML editor to create and edit the text for the problem statement. In some embodiments, the system includes an open source WYSIWYG editor based on a Java Script framework. In other embodiments, the editor may be any of the Open Source components such as “Tiny MCE” editor by Moxiecode Systems AB of Skellefteå, Sweden, “FCKeditor” WYSIWYG HTML editor (open source), or a similar open source Java-based utility.

Brief analyzer module 102 analyses the problem brief to suggest a search criteria. This module suggests keywords, keyphrases, proximity phrases, or a combination of all of these. In some embodiments, the brief analyzer module 102 uses the “SIMPLE” program from IBM Corporation of Armonk, N.Y. “SIMPLE” analyzes content and incorporates analytical techniques to the information to derive this information. “SIMPLE” uses clustering algorithms, classification, entity extraction and annotation algorithms.

Search module 103 uses the search criteria so generated to search all available expert networks and data sources. These data sources can be profile data sources or content data sources, as shown in 221, 222, 211, and 212. The system connects to these data sources over the Internet using http or https protocol or over a private network, and performs searches within each of the data sources by using the web services provided by and specified for these data sources. In some embodiments, the underlying databases and search engine capabilities of the remote data sources execute search calls and return information to the end user. In some embodiments, the underlying repositories make use of the Open Source Apache Lucene full featured text search engine whereby the search module 103 directly passes the query utilizing the Lucene syntax. The information request is processed on the remote server and a response formed which is then streamed back to the search module 103 for further processing. The search module 103 makes Application Programmatic Interface (API) calls or requests to the various repositories using either standard HTTP GET or POST requests for information. The information request is processed on the remote server and an HTTP response formed which is then streamed back to the search module 103 for further processing and/or display to the end user.

Under step 104 the Search Module collects the search results from all data sources and then analyzes the results to derive the relevance scores i.e. a value to indicate how relevant the search results are to the input search query. In some embodiments, the underlying search engine and its relevancy ranking algorithms and functionality provide this information. These ranking algorithms vary by search engine and database searched.

The network analyzer module 105 finds known entities from amongst the search results. The entities include people or organizations that are returned by the search. The known entities are the entities that the user or a colleague of the user has, already visited and stored in the proprietary network. Based on the type of entity (organization or individual) additional processing may occur.

This system then presents the results along with results augmentation using a user interface or 106. The augmentation may include the matching of additional information to the entity (organization or individual) returned in step 105. This matching and/or augmentation may be accomplished by using the entities name as the search query and then searching across a series of data sources that are specific to entities (organizations or individuals) and their experience (profile). This search process is similar to that which is employed in the more generalized information search routines with the entity ‘name’ now being the search string or query.

Another user interface 107 allows the user to select the most relevant results based on the analysis and results augmentation provided by the system.

The profile builder module now takes each search result and extracts the name of the author in step 108. For the data sources that provide the author name or the persons' name in a separate data field, this step is very simple as it just requires copying the name without any extraction or transformation. For other data sources with the name is part of free-form text or a sentence, this step requires using a normalization procedure to extract the author name based on known pattern in the free form text. Using a similar procedure and depending on the data source, the system may also find a generic area of expertise, employer, location or other demographic data which can later be used for identifying the person in other data sources.

Under step 109 profile builder module uses key data fields such as a name, employer, location or other such demographic data to formulate search query to find people in other data sources and networks (211, 212, 221 and 222). These data sources and networks may be the same as those searched in, step 103 or may include additional sources and networks. In other embodiments, this is a different query (from the query of step 103) made to the same data set searched in step 103. As in step 103 the system uses web services API provided by these data sources.

Once profile builder obtains the search results, it normalizes the results (110) to form common data structure and then rank the results (111) for confidence level about the closeness of the match. In some embodiments, name matching is used as a first order normalization. These routines look at various combinations of first name; last name; first initial, last name; and other combinations to determine if there is a match in the system. Closeness of match refers to the identification of people based on profiles in different systems and the likelihood that an expert profiled in one system is that same expert in the other system. This comparison may use a simple name matching algorithm, present the possible matches to the user, and allow the user to visually inspect the similar matches and determine through inspection whether they are indeed a match. Once the user makes this determination, he manually selects and adds the result to his group of individuals that are of interest to him. The system ranks the results based on which criteria have been matched and the relative weight of each criterion.

Profile match search results are then presented to the user in a user interface (112) in a web browser. Profile builder also stores a unique identification for each match under each data source; these unique identifiers at remote data sources enable the system to retrieve the profile on-demand. For a given person the collection of these profiles at various data sources represents the Composite Profile.

All of the activities are performed in the web servers and the application servers. These servers reside in one virtual private network (VPN) and connect to other servers outside of this VPN by using the Internet protocol (http or https). The user also connects to these web servers via Internet protocols.

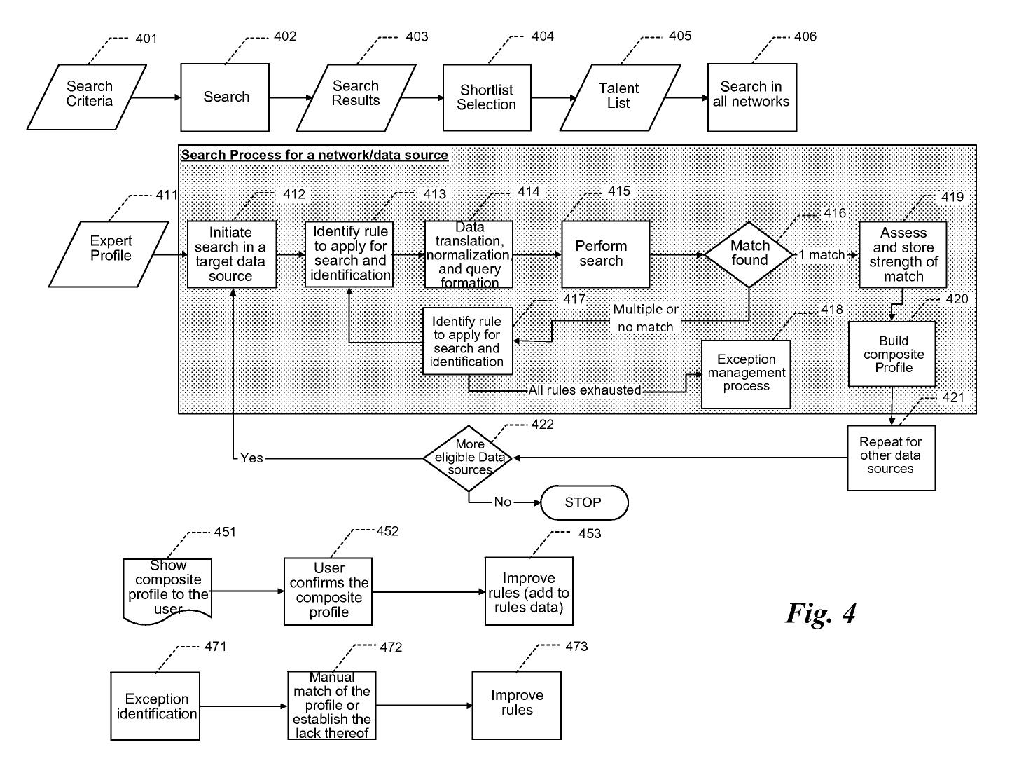

The system and method for matching a profile in a remote data source is further detailed in FIG. 4. Steps 411 to 420 detail how the expert profile of a given data source is matched against another data source. Step 109 includes performing steps 411 to 420 once in their entirety for each data source that need to be searched to identify the expert at those data sources e.g. if the expert profile is to be identified at 5 data sources the system will perform steps'411 to 420 five times, once for each data source.

Given an expert profile (411) from a given data source the system first identifies an appropriate rule from the rules repository (412, 413) that applies to the pair of data sources (pair of two data sources: one data source is that from which the expert profile was first retrieved and the other is the data source being searched). The rule contains knowledge about how the data fields are to be matched e.g. if one data source is a patent source and the other data source represents a professional network or a resume source the rule will require using “assignee” information to match against the “present or past employer” field in the other data source. Such a transformation is performed under step 414. The system then performs the search (415) with the criteria derived based on the rule. If no match is found the profile builder module looks up the next rule to apply for matching. The rules are ordered by stringency with the most stringent matching rule first. If a unique match is found the system then assesses the match and its strength (419). The system also stores the unique ID of the profile at the data source that was searched.

The Composite Profiles stored in the system are then also used to correlate search results in remote databases to Talent that already exists in the in-house data store. For example, if a person John Smith is found to have matching expertise based on a published scientific article (step 121 and 122), the system will use the Composite Profile of John Smith to check and determine whether that person is already in the in-house data store and present that information (step 123).

The methods described herein may be at least partially embodied in the form of computer-implemented processes and apparatus for practicing those processes. The disclosed methods may also be at least partially embodied in the form of tangible, non-transient machine readable storage media encoded with computer program code. The media may include, for example, RAMs, ROMs, CD-ROMs, DVD-ROMs, BD-ROMs, hard disk drives, flash memories, or any other non-transient machine-readable storage medium, wherein, when the computer program code is loaded into and executed by a computer, the computer becomes an apparatus for practicing the method. The methods may also be at least partially embodied in the form of a computer into which computer program code is loaded and/or executed, such that, when the computer program code is loaded into and executed by a computer, the computer becomes an apparatus for practicing the methods. When implemented on a general-purpose processor, the computer program code segments configure the processor to create specific logic circuits. The methods may alternatively be at least partially embodied in a digital signal processor formed of application specific integrated circuits for performing the methods.

Although the subject matter has been described in terms of exemplary embodiments, it is not limited thereto. Rather, the appended claims should be construed broadly, to include other variants and embodiments, which may be made by those skilled in the art.

What is claimed is:

1. A method comprising:
(a) receiving a problem statement from a user;
(b) automatically generating a search query based on the problem statement;
(c) using the search query to perform a database search of a plurality of databases that are stored in a machine readable storage media accessible via one or more of the Internet, a local area network, or a local drive;
(e) generating and outputting an identification of a ranked set of documents and/or information to the user in response to the search query;
(f) receiving from the user identification of a subset of the ranked set; and
(g) automatically extracting a set of names of experts from the subset.

2. The method of claim 1, further comprising:
(h) automatically searching for additional documents and information related to each of the experts; and
(i) constructing and storing a respective profile for each expert.

3. The method of claim 2, wherein step (h) includes:
applying a rule to determine a second field in a second data source corresponding to a first field used in a first data source, the first field containing information related to the expert; and
searching in the second field in the second data source for information matching the information in the first field of the first data source.

4. The method of claim 1, wherein step (b) includes generating a list of suggestions from at least one of the group consisting keywords, keyphrases, and proximity phrases.

5. The method of claim 1, wherein step (g) includes matching a first author of a first document to a second author of a second document, partly based on additional information.

6. The method of claim 5, wherein the additional information includes at least one of the group consisting of author expertise, author employer, author location and/or assignee.

7. A persistent machine readable storage medium encoded with computer program code, such that when the computer program code is executed by a processor, the processor performs the method comprising:
(a) receiving a problem statement from a user;
(b) automatically generating a search query based on the problem statement;
(c) using the search query to perform a database search of a plurality of databases that are stored in a machine readable storage media accessible via one or more of the Internet, a local area network, or a local drive;
(e) generating and outputting an identification of a ranked set of documents and/or information to the user in response to the search query;
(f) receiving from the user identification of a subset of the ranked set; and
(g) automatically extracting a set of names of experts from the subset.

8. The storage medium of claim 7, wherein the method further comprises:
(h) automatically searching for additional documents and information related to each of the experts; and
(i) constructing and storing a respective profile for each expert.

9. The method of claim 8, wherein step (h) includes:
applying a rule to determine a second field in a second data source corresponding to a first field used in a first data source, the first field containing information related to the expert; and
searching in the second field in the second data source for information matching the information in the first field of the first data source.

10. The method of claim 7, wherein step (b) includes generating a list of suggestions from at least one of the group consisting keywords, keyphrases, and proximity phrases.

11. The method of claim 7, wherein step (g) includes matching a first author of a first document to a second author of a second document, partly based on additional information.

12. The method of claim 11, wherein the additional information includes at least one of the group consisting of author expertise, author employer, author location and/or assignee.

13. A system comprising:
a server processor coupled to the Internet and configured to receive a problem statement from a user and automatically generate a search query based on the problem statement;
said server processor configured to use the search query to perform a database search of a plurality of databases that are stored in a machine readable storage media accessible via one or more of the Internet, a local area network, or a local drive;
said server processor configured to generate and output an identification of a ranked set of documents and/or information to the user in response to the search query;
said server processor configured to receive from the user an identification of a subset of the ranked set, and automatically extract a set of names of experts from the subset.

14. The system of claim 13, wherein the server is further configured for:
automatically searching for additional documents and information related to each of the experts; and
constructing and storing a respective profile for each expert in a data repository.

15. The method of claim 14, wherein constructing the profile includes:
applying a rule to determine a second field in a second data source corresponding to a first field used in a first data source, the first field containing information related to the expert; and
searching in the second field in the second data source for information matching the information in the first field of the first data source.

16. The system of claim 13, wherein generating the search query includes generating a list of suggestions from at least one of the group consisting keywords, keyphrases, and proximity phrases.

17. The system of claim 13, wherein constructing the profile includes matching a first author of a first document to a second author of a second document, partly based on additional information.

18. The system of claim 17, wherein the additional information includes at least one of the group consisting of author expertise, author employer, author location and/or assignee.
